(19) United States
(12) Patent Application Publication
(10) Pub. No.: US 2023/0284354 A1
(43) Pub. Date: Sep. 7, 2023

(54) CURRENT-LIMITING DRIVER CIRCUIT AND METHOD

(71) Applicant: VERSITECH LIMITED, Hong Kong (CN)

(72) Inventor: Ron Shu Yuen HUI, Hong Kong (CN)

(21) Appl. No.: 17/766,461

(22) PCT Filed: Aug. 17, 2020
(86) PCT No.: PCT/CN2020/109608

§ 371 Date: Apr. 4, 2022

Related U.S. Application Data
(60) Provisional application No. 62/910,683, filed on Oct. 4, 2019.

(51) Int. Cl. H05B 45/3725; H05B 47/25

(52) U.S. Cl. CPC H05B 45/3725; H05B 47/25

(57) ABSTRACT

A driver circuit comprising an input inductor for receiving an input current provided to the driver circuit, and one or more switchable capacitors. Each switchable capacitor is switchable to connect in parallel across the input inductor and to disconnect from the input inductor, the input inductor and the switchable capacitors together thereby providing a variable impedance corresponding to the number of switchable capacitors are switched to connect to the input inductor, with the variable impedance variably limiting the input current. An associated method and an associated system are also provided.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent claims priority from International PCT Patent Application No. PCT/CN2020/109608, filed Aug. 17, 2020 entitled, “CURRENT-LIMITING DRIVER CIRCUIT AND METHOD”, which claims priority to U.S. Provisional Application No. 62/910,683, filed Oct. 4, 2019, all of which are incorporated herein by reference in their entirety.

### BACKGROUND

The invention relates to current-limiting driver circuits and methods of limiting an input current, and in particular, those for driving load circuits requiring a variably limited input current. The invention is described primarily for use in driving lighting load circuits based on light emitting diodes (LEDs), but the invention is not limited to this particular use.

### BACKGROUND OF THE INVENTION

Electronic drivers for light emitting diode (LED) systems are usually based on switched mode power supply technology. These tend to use semiconductor power switches controlled by gate drive circuits and integrated control circuits. Most of these also use electrolytic capacitors as energy buffers. For outdoor applications such as street lighting, electronic LED drivers are less reliable due to wide ranges of temperature variations and frequent lightning in those applications. Electrolytic capacitors are also known for their short lifetimes.

The present inventor has previously proposed passive LED drivers, including those disclosed in U.S. Pat. 8,482,214 and 9,717,120, and U.S. Pat. Publication 2015/0296575. Unlike electronic (or active) LED drivers, these passive LED drivers do not use semiconductor power switches controlled by gate drive circuits, integrated control circuits, or electrolytic capacitors.

Since passive LED drivers do not contain any electronic control in general, they are not designed with dimming functions. Instead, dimming functions with the aid of external circuits have been previously suggested. In U.S. Pat. 8,482,214, two methods are proposed. First, an inductor with tapping control is suggested to change the impedance of the input inductor for dimming control as shown in FIG. 5. This tapping controlled inductor can either be formed with the main input inductor or in the form of an additional inductor to the main input inductor. Second, a controlled current source can be used to alter the impedance of the input inductor. However, the former method requires tapping of the inductor, which makes the manufacture of the input inductor expensive. The latter method is more expensive because it requires a controlled current source.

It is an object of the present invention to overcome or ameliorate at least one of the disadvantages of the prior art, or to provide a useful alternative.

### Summary of the Invention

Embodiments of the present invention in a first aspect provide a driver circuit comprising:
an input inductor for receiving an input current provided to the driver circuit; and
one or more switchable capacitors, each being switchable to connect in parallel across the input inductor and to disconnect from the input inductor, the input inductor and the switchable capacitors together thereby providing a variable impedance corresponding to the number of switchable capacitors are switched to connect to the input inductor, with the variable impedance variably limiting the input current.

Embodiments of the present invention in a second aspect provide a method of limiting an input current, the method comprising:
receiving an input current with an input inductor; and
switching one or more switchable capacitors to connect in parallel across the input inductor or to disconnect from the input inductor, the input inductor and the switchable capacitors together thereby providing a variable impedance corresponding to the number of switchable capacitors are switched to connect to the input inductor, with the variable impedance variably limiting the input current.

Embodiments of the present invention in a third aspect provide an LED lighting system driven by a driver circuit described above in respect of the first aspect.

Other features and embodiments of the present invention can be found in the appended claims.

Throughout this specification, including the claims, the words “comprise”, “comprising”, and other like terms are to be construed in an inclusive sense, that is, in the sense of “including, but not limited to”, and not in an exclusive or exhaustive sense, unless explicitly stated otherwise or the context clearly requires otherwise.

### DESCRIPTION OF THE DRAWINGS

Preferred embodiments in accordance with the best mode of the present invention will now be described, by way of example only, with reference to the accompanying figures, in which the same reference numerals refer to like parts throughout the figures unless otherwise specified, and in which:

FIG. 1 is a circuit schematic of a prior passive LED driver as disclosed by U.S Pat. 8,482,214 to which embodiments of the present invention are well-suited;

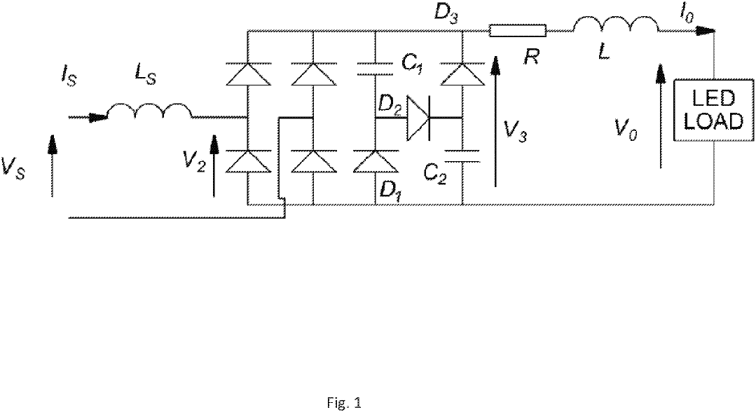

FIG. 2 is a circuit schematic of a prior passive LED driver as disclosed by U.S. Pat. Publication 2015/0296575 to which embodiments of the present invention are well-suited;

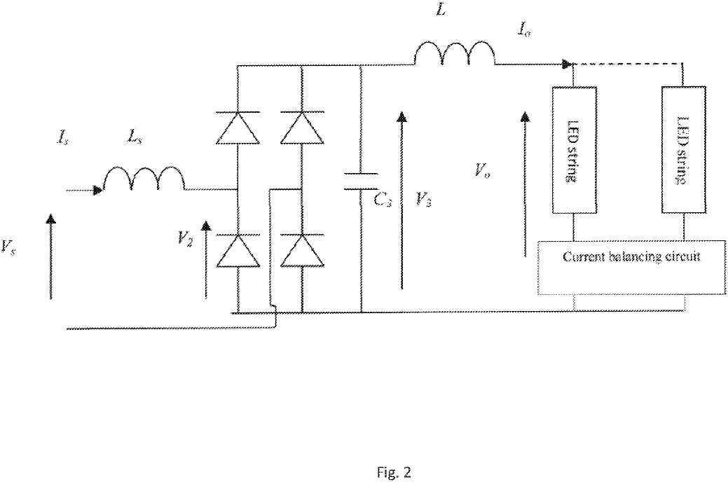

FIG. 3 is a circuit schematic of another prior passive LED driver as disclosed by U.S. Pat. Publication 2015/0296575 to which embodiments of the present invention are well-suited;

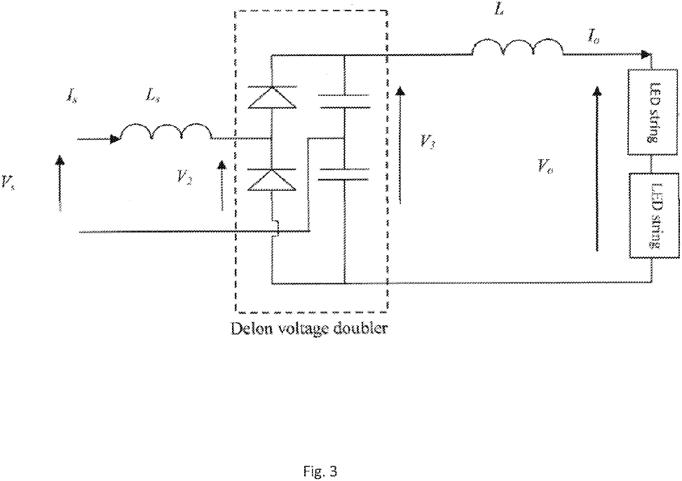

FIG. 4 is a circuit schematic of a prior passive LED driver to which embodiments of the present invention are well-suited;

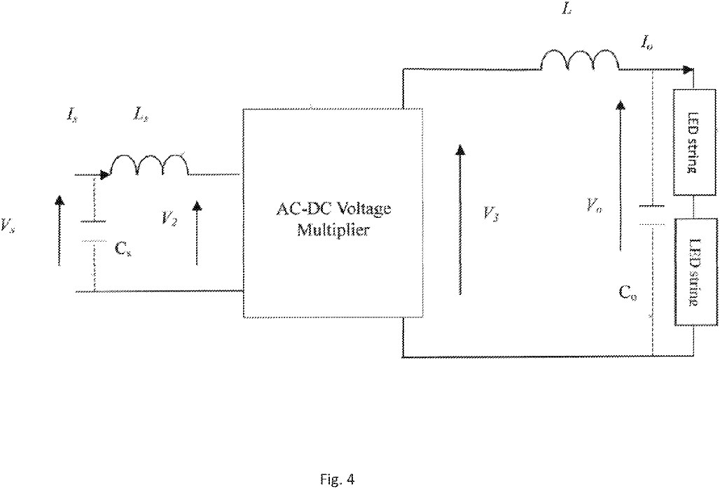

FIG. 5 is a circuit schematic of a prior circuit using a switchable input inductor to dim an LED circuit as disclosed by U.S. Pat. 8,482,214;

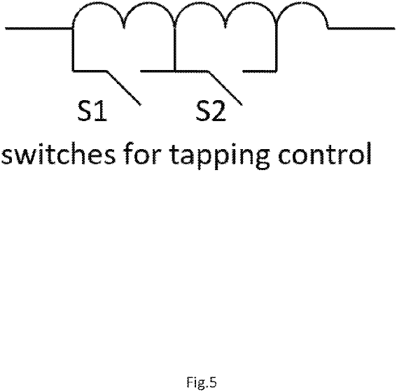

FIG. 6 is a circuit schematic of a prior circuit using a controlled current source to alter the impedance of an input inductor to dim an LED circuit as disclosed by U.S. Pat. 8,482,214;

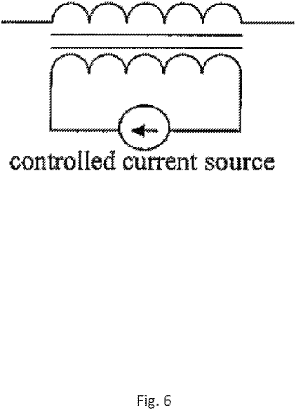

FIG. 7 is a circuit schematic of a prior passive LED driver to which embodiments of the present invention are well-suited;

FIG. 8 is a circuit schematic of a driver circuit in accordance with an embodiment of the present invention;

FIG. 9 is a circuit schematic of a driver circuit in accordance with an embodiment of the present invention;

FIG. 10 is a simplified circuit schematic of a driver circuit in accordance with an embodiment of the present invention;

FIG. 11 is another simplified circuit schematic of a driver circuit in accordance with an embodiment of the present invention;

FIG. 12 is a graph of the dimming characteristic of a driver circuit driving an LED load in accordance with an embodiment of the present invention, showing the LED load power on the y-axis corresponding to the number of connected switchable capacitors on the x-axis; and

FIG. 13 is a graph of the simulated output power of the embodiment of FIG. 8.

### DETAILED DESCRIPTION OF PREFERRED EMBODIMENTS OF THE INVENTION

Referring to the figures, there is provided a driver circuit 1 comprising an input inductor Lₛ for receiving an input current Iₛ provided to the driver circuit, and one or more switchable capacitors C_{dN} and S_{N} (i.e. C_{d1} and S₁, C_{d2} and S₂, ..., C_{dN} and S_{N}). Each switchable capacitor C_{dN} and S_{N} is switchable to connect in parallel across the input inductor Lₛ and to disconnect from the input inductor Lₛ, the input inductor Lₛ and the switchable capacitors C_{dN} and S_{N} together thereby providing a variable impedance Z_{eq} corresponding to the number of switchable capacitors are switched to connect to the input inductor, with the variable impedance Z_{eq} variably limiting the input current Iₛ. The input current Iₛ limited in this way is shown as I_{eq}.

The switchable capacitor C_{dN} and S_{N} comprises a capacitor C_{dN} and a bidirectional switch S_{N} switchable to connect the capacitor C_{dN} in parallel across the input inductor Lₛ and to disconnect the capacitor C_{dN} from the input inductor Lₛ. The bidirectional switch S_{N} can be one or more of the following: an electromechanical relay; a contactor; a solid-state relay; an electromagnetic relay; a controllable semiconductor switch; a power electronic switch; a MOSFET; an insulated gate bipolar transistor; and a thyristor. It is appreciated however that the bidirectional switch can be any switching device that is capable of switching to connect the capacitor C_{dN} in parallel across the input inductor Lₛ and to disconnect the capacitor C_{dN} from the input inductor Lₛ. Advantageously, the capacitor C_{dN} is a non-electrolytic capacitor.

In the present embodiments, the input current Iₛ is provided by an AC (alternating current) voltage supply or an AC mains voltage Vₛ. The driver circuit 1 comprises a rectifying circuit 2 for rectifying an AC input power into a DC output power. In particular, the input current Iₛ and input (or supply) voltage Vₛ is rectified to an output current Iₒ and output voltage Vₒ. The rectifying circuit 2 can be any circuit that is capable of rectifying an AC input power into a DC output power, such as: a full-bridge diode rectifier; a half-bridge diode rectifier; a voltage doubling half-bridge diode rectifier; a voltage-multiplying full-bridge diode rectifier; and a voltage multiplying half-bridge diode rectifier. The driver circuit 1 can also comprise a voltage smoothing circuit 3 for smoothing an output voltage Vₒ from a rectifying circuit 2. The voltage smoothing circuit 3 can be one or more of the following: a capacitor C₂; and a valley-fill circuit. The driver circuit 1 can also comprise an output inductor Lₒ for providing a smoothed output current Iₒ. The driver circuit 1 can additionally comprise an input capacitor Cₛ for power factor correction. Furthermore, the driver circuit 1 can comprise an output capacitor Cₒ for providing a closed path for an output current Iₒ in case a load circuit 4 driven by the driver circuit 1 is removed or damaged.

Advantageously, the driver circuit 1 is passive. In other words, the driver circuit 1 does not require any active components. This leads to a much more durable and reliable driver circuit 1 with a relatively longer operational lifetime, as well as a less expensive driver circuit 1. Also advantageously, the driver circuit 1 comprises no electrolytic capacitors. This avoids the problem of the relatively limited or short lifetime of electrolytic capacitors, resulting again in a much more durable and reliable driver circuit 1 with a relatively longer operational lifetime.

The driver circuit 1 can comprise a control unit for controlling the switching of the switchable capacitors C_{dN} and S_{N} thereby controllably limiting the input current Iₛ. The control unit can provide automatic control of the switching of the switchable capacitors C_{dN} and S_{N}. The automatic control can be dependent on an environmental sensor. For example, the environmental sensor can be an ambient light sensor, and the control unit switches one or more of the switchable capacitors C_{dN} and S_{N} to connect to the input inductor Lₛ to dim an LED load 4 driven by the driver circuit 1 when the ambient light sensor senses an increased ambient light level. The control unit can provide manual control of the switching of the switchable capacitors C_{dN} and S_{N} to a user. For example, a user can switch one or more of the switchable capacitors C_{dN} and S_{N} to disconnect from the input inductor Lₛ to brighten an LED load 4 driven by the driver circuit 1 when an increased lighting level is desired. As illustrated in these examples, the driver circuit 1 is well-suited to be adapted to drive one or more LEDs 4, with the variable impedance Z_{eq} thereby providing controllable dimming of the LEDs 4. The driver circuit 1 is also well-suited to be adapted to drive HID (high intensity discharge) lamp systems, with the variable impedance Z_{eq} thereby providing controllable dimming of the HID lamps. The driver circuit 1 is in fact well-suited to drive any other load circuits requiring a variably limited input current.

In another aspect of the present invention, there is provided an LED lighting system 5 driven by a driver circuit according to any one of the embodiments described above. In yet another aspect of the present invention, there is provided a HID lamp lighting system driven by a driver circuit according to any one of the embodiments described above.

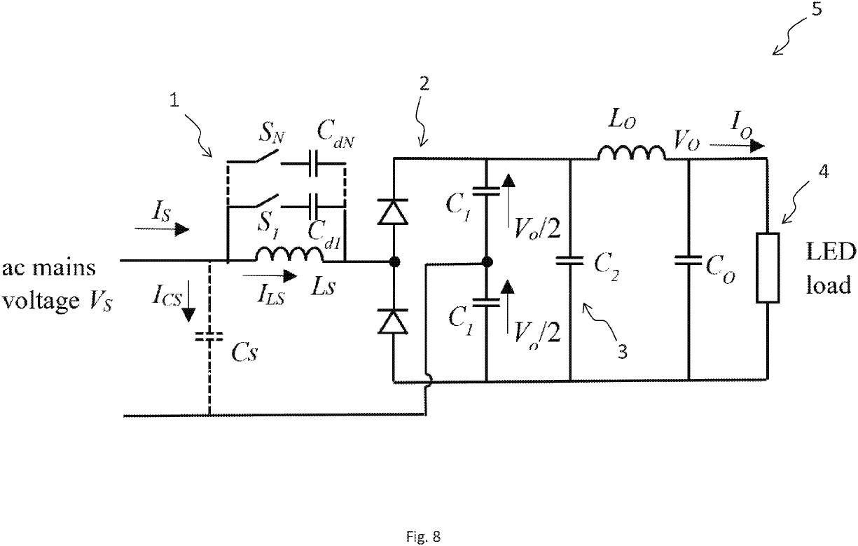

In the embodiment shown in FIG. 8, the driver circuit 1 receives AC mains voltage Vₛ. This provides input current Iₛ which is received by the input inductor Lₛ. Each switchable capacitor C_{dN} and S_{N} is switchable to connect in parallel across the input inductor Lₛ and to disconnect from the input inductor Lₛ, the input inductor Lₛ and the switchable capacitors C_{dN} and S_{N} together thereby providing a variable impedance Z_{eq} corresponding to the number of switchable capacitors are switched to connect to the input inductor, with the variable impedance Z_{eq} variably limiting the input current Iₛ. The input current Iₛ limited in this way is shown as I_{eq}. Iₛ (as I_{eq}) and Vₛ are then rectified by rectifying circuit 2 into the output current Iₒ and the output voltage Vₒ. The voltage smoothing circuit 3 in the form of smoothing capacitor C₂ connected across the rectifying circuit 2 smoothes the output voltage Vₒ provided by the rectifying circuit 2. The output inductor Lₒ is connected after the voltage smoothing circuit 3 to provide the smoothed output current Iₒ. The input capacitor Cₛ is connected between the AC mains voltage Vₛ and the input inductor Lₛ (which is combined with one or more parallel switched capacitors C_{dN} and S_{N}) for power factor correction. The output capacitor Cₒ is connected across the load circuit 4 (after the output inductor Lₒ in the present embodiment) to provide a closed path for an output current Iₒ in case the load circuit 4 driven by the driver circuit 1 is removed or damaged.

In a further aspect of the present invention, there is provided a method of limiting an input current. Embodiments of the method comprise receiving an input current Iₛ with an input inductor Lₛ, and switching one or more switchable capacitors C_{dN} and S_{N} (i.e. C_{d1} and S₁, C_{d2} and S₂, ..., C_{dN} and S_{N}) to connect in parallel across the input inductor Lₛ or to disconnect from the input inductor Lₛ. The input inductor Lₛ and the switchable capacitors C_{dN} and S_{N} together thereby providing a variable impedance Z_{eq} corresponding to the number of switchable capacitors switched to connect to the input inductor, with the variable impedance Z_{eq} variably limiting the input current Iₛ. The input current Iₛ limited in this way is shown as I_{eq}.

In the present embodiments, the input current Iₛ is provided by an AC voltage supply or an AC mains voltage Vₛ. The method comprises rectifying an AC input power into a DC output power. In particular, the input current Iₛ and input (or supply) voltage Vₛ is rectified to an output current Iₒ and output voltage Vₒ. The method also comprises smoothing an output voltage Vₒ from a rectifying circuit 2. The method also comprises smoothing an output current Iₒ before providing the output current to a load circuit 4. The method can additionally comprise providing power factor correction to an input power (Vₛ and Iₛ). Furthermore, the method can comprise closing a path for an output current Iₒ in case a load circuit 4 driven by the method is removed or damaged.

Advantageously, the method only uses passive components. Also advantageously, the method does not use electrolytic capacitors. The method can also comprise controlling the switching of the switchable capacitors C_{dN} and S_{N} thereby controllably limiting the input current Iₛ.

As described above, embodiments of the method can comprise and are well-suited to using the variably limited input current to drive one or more LEDs 4, thereby providing controllable dimming of the LEDs 4. Other embodiments of the method can comprise and are well-suited to using the variably limited input current to drive one or more HID (high intensity discharge) lamps, thereby providing controllable dimming of the HID lamps. In fact, the method can comprise and is well-suited to using the variably limited input current to drive any other load circuits requiring a variably limited input current.

Passive LED driver circuits are naturally compatible with external voltage control for dimming purposes. External voltage control can come from a central transformer with tapping control for voltage variation or a central controllable voltage source. Embodiments of the present invention however provide a simple and low-cost dimming circuit and method for passive LED driver circuits, especially those designed to be powered by standard AC mains, although the same system can still operate properly when the AC mains is altered within a safe voltage range.

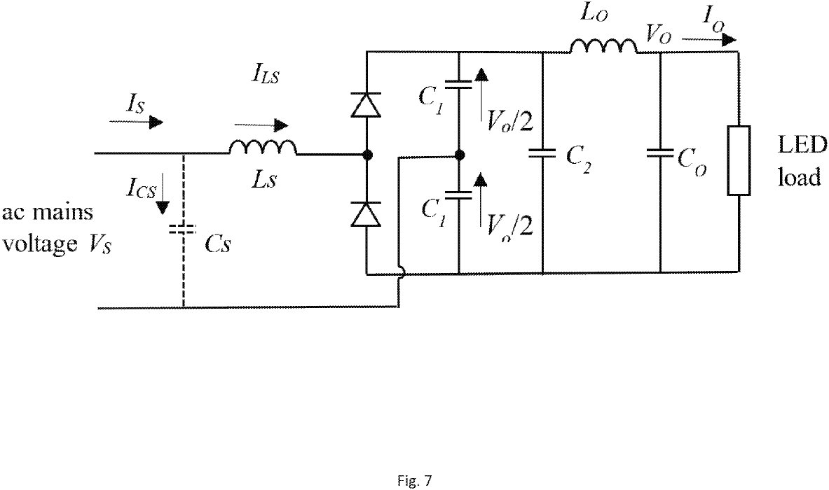

FIG. 7 shows a typical passive LED system comprising: an input inductor Lₛ; a half-bridge diode voltage doubler (with two diodes and two capacitors C₁); a smoothing capacitor C₂; an output inductor Lₒ for smoothing the output current Iₒ; a small output capacitor Cₒ for providing a closed path for the output current Iₒ in case the LED load 4 is removed or damaged during operation; and an input capacitor Cₛ for power factor correction.

It is important to note that all the capacitors in FIG. 7 are of a solid type, meaning that electrolytic capacitors that contain liquid electrolyte are not needed. This feature makes the passive LED drivers highly reliable and durable. When choosing the power diodes, as long as the i²t ratings of the diodes are larger than those of the protective fuses in the system, the passive LED system can enjoy long lifetime because power diodes are the most reliable power semiconductor devices.

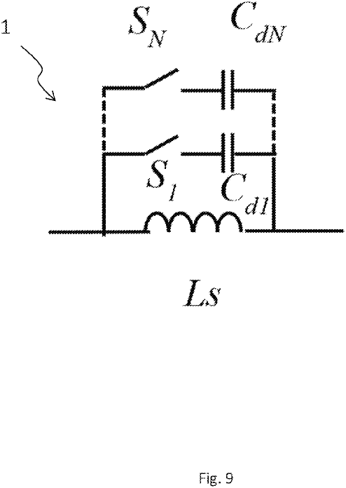

From the basis of the circuit shown in FIG. 7, embodiments of the present invention introduce switchable parallel capacitor or capacitors C_{dN} and S_{N} across the main input inductor Lₛ (for limiting the input current Iₛ and also the output power), as best shown in FIG. 8, in order to adjust the overall impedance of the combination of the input inductor Lₛ and the switchable capacitors C_{dN} and S_{N}. This combination of the input inductor Lₛ and the switchable capacitors C_{dN} and S_{N}, as best shown in FIG. 9, can be referred to as an “input-current-limiting device”. As best shown FIG. 8, the bidirectional switch S_{N} is used to connect a capacitor C_{dN} across the main inductor L_{S}. The value of the parallel capacitance connected across Lₛ can be altered by using one or more parallel circuit branch of S_{N} and C_{dN} as best shown in FIG. 8. In this way, the equivalent capacitance across Lₛ can be changed in discrete steps, with each step representing a respective dimming setting of the passive LED system 5. Again, all the capacitors in FIG. 8 are of a solid type and are not electrolytic capacitors. The bidirectional switches S_{N} can be electromechanical relays, contactors, solid-state relays, or controllable semiconductor switches configured as bidirectional switches.

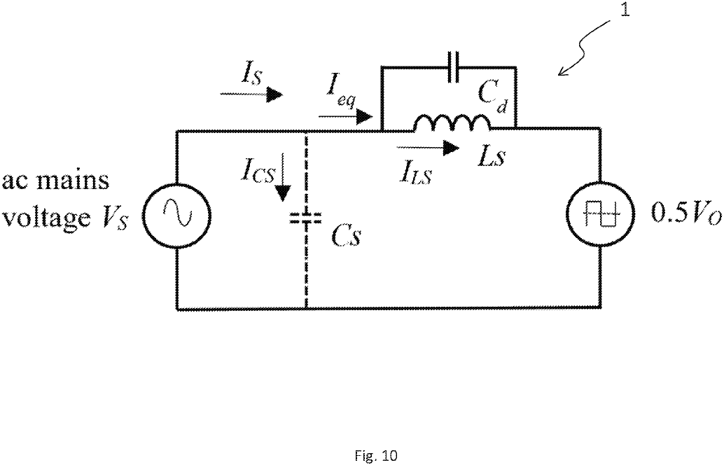

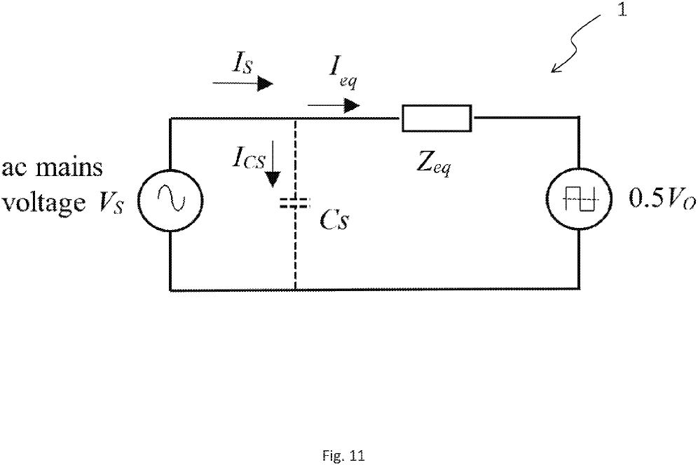

The inductor current passing through the switchable parallel capacitors C_{dN} and S_{N} and the main inductor Lₛ can be represented in simplified equivalent circuits as shown in FIG. 10 and FIG. 11. Here, C_{dN} in FIG. 8 can be referred to as a “dimming capacitor” because each addition of the capacitor C_{dN} (i.e. C_{D1}, C_{D2}, ..., C_{dN}) across the main inductor Lₛ represents one dimming setting (where the first subscript “d” represents that the capacitor is used for dimming and the second subscript “N” = 1, 2, ..., N, where N is the number of dimming settings). For example, if two dimming settings of 85% and 70% of full power are needed, two sets of bidirectional switch S_{N} and dimming capacitor C_{dN} branches are needed. The bidirectional switch S_{N} and dimming capacitor C_{dN} in each branch are series connected, and each branch is connected in parallel across the input indictor Lₛ. In this particular example shown in FIG. 8, N = 2.

Now, let C_{d} be the total equivalent dimming capacitance used for one particular dimming setting. A simplified equivalent circuit of the passive LED system with a half-bridge diode rectifying voltage doubler shown in FIG. 8 is shown in FIG. 10. The simplified equivalent circuit shown in FIG. 10 can be further simplified as the equivalent circuit shown in FIG. 11.

The parallel-connected Lₛ and C_{d} form an equivalent impedance Z_{eq}, which can be expressed as:

$${Z}_{e q} = \frac{j ω {L}_{s}}{1 - {ω}^{2} {L}_{s} {C}_{d}} = \frac{{Z}_{L s}}{k} \qquad \text{Equation (1)}$$

where Z_{Ls} is the impedance of Lₛ and

$$k = \left(1 - {ω}^{2} {L}_{s} {C}_{d}\right) \qquad \text{Equation (2)}$$

and the factor k ≤ 1.

Equation (1) indicates that adding parallel C_{d} will reduce k and increase the equivalent impedance from Z_{Ls} to Z_{eq}. Since Z_{eq} > Z_{Ls} when C_{d} > 0, the increase in the current-limiting impedance will reduce the input mains current and thus the power in the LED load 4. This important feature is adopted for dimming purposes in embodiments of the present invention.

The general equation for the main inductor current I_{LS} without dimming in FIG. 7 and with dimming in FIG. 8 is the same:

$${I}_{L s} = \frac{{V}_{s} - 0.5 {V}_{O}}{j ω {L}_{s}} = \frac{{V}_{s} - 0.5 {V}_{O}}{{Z}_{L s}} \qquad \text{Equation (3)}$$

For the case of “full” power (i.e. without dimming), the main inductor current is indicated as I_{LsF}. Now, consider the equivalent circuit under dimming in FIG. 11, the equivalent current of Z_{eq} is:

$${I}_{e q} = \frac{{V}_{s} - 0.5 {V}_{O}}{{Z}_{e q}} = \left(\frac{{V}_{s} - 0.5 {V}_{O}}{{Z}_{L s}}\right) \left(1 - {ω}^{2} {L}_{s} {C}_{d}\right) \qquad \text{Equation (4a)}$$

$${I}_{e q} = {I}_{L s F} k \qquad \text{Equation (4b)}$$

where I_{LsF} is the current of the main inductor Lₛ at full power of the passive LED system 5.

Equations (4a) and (4b) indicate that the k-factor in Equation (2) can be considered as a dimming factor. However, it is important to note that the actual dimming percentage of the passive LED system 5 in FIG. 8 is also affected by other factors such as the power factor correction capacitor Cₛ. In general, Cₛ is designed to achieve unity or near-unity power factor at the full power of the passive LED system 5. When I_{eq} is different from I_{LsF}, the Cₛ no longer compensates the reactive power to achieve unity input power factor.

A simple approach to design C_{d1}, C_{d2}, etc. to achieve precise dimming power levels is to use a computer simulation study. For example, based on the system shown in FIG. 8, the parameters of a 120 W passive LED system 5 used for one simulation study were:

Vₛ = 220 V (50 Hz), Lₛ = 0.55 H (with a winding resistance of 3.35 Ohm), C₁ = 80 µF, C₂ = 20 µF, Cₛ = 15 µF, Cₒ = 0.6 µF, and Lₒ = 0.3 H. The LED string 4 had a total voltage of 210 V and a string resistance of 3 Ohm.

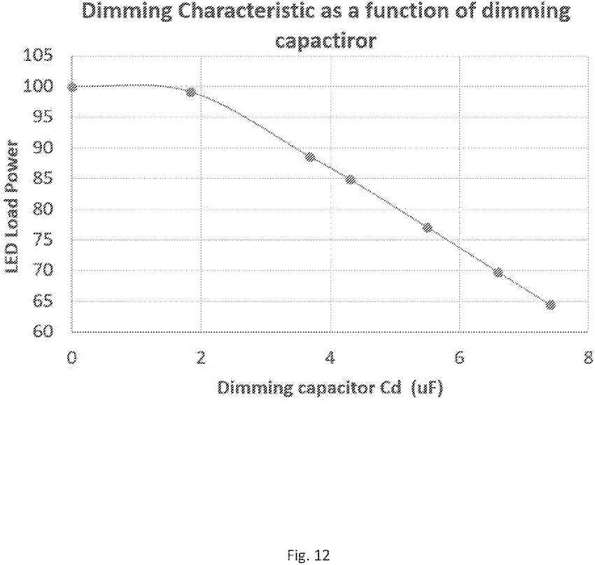

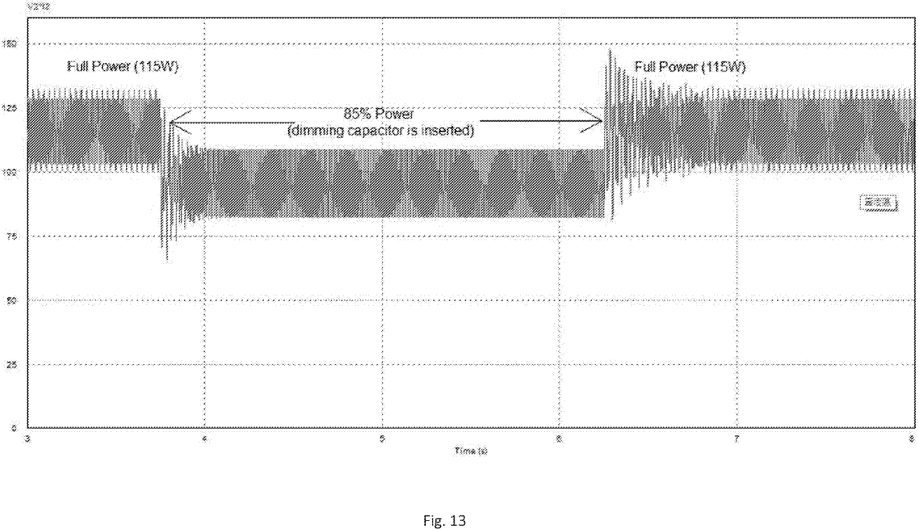

FIG. 12 shows the dimming percentage of the passive LED system 5 against a range of dimming capacitors C_{d}. If a dimming setting of 85% power is needed, a dimming capacitor C_{d} = 4.3 uF is required. FIG. 13 shows the simulated output power of the 120 W rated passive LED system 5 when switchable dimming capacitor C_{d} of 4.3 uF is switched into and out of the LED system 5. It can be seen that the output power is at a full power of 115 W when C_{d} = 0 and becomes 98 W when C_{d} = 4.3 uF. Thus, the dimming function of the switchable parallel capacitor method according to embodiments of the present invention is confirmed.

It is also appreciated that the aforesaid embodiments are only exemplary embodiments adopted to describe the principles of the present invention, and the present invention is not merely limited thereto. Various variants and modifications can be made by those of ordinary skill in the art without departing from the spirit and essence of the present invention, and these variants and modifications are also covered within the scope of the present invention. Accordingly, although the invention has been described with reference to specific examples, it is appreciated by those skilled in the art that the invention can be embodied in many other forms. It is also appreciated by those skilled in the art that the features of the various examples described can be combined in other combinations.

It is claimed:

1. A driver circuit comprising:
an input inductor for receiving an input current provided to the driver circuit; and
one or more switchable capacitors, each being switchable to connect in parallel across the input inductor and to disconnect from the input inductor, the input inductor and the switchable capacitors together thereby providing a variable impedance corresponding to the number of switchable capacitors are switched to connect to the input inductor, with the variable impedance variably limiting the input current.

2. A driver circuit according to claim 1 wherein the switchable capacitor comprises a capacitor and a bidirectional switch switchable to connect the capacitor in parallel across the input inductor and to disconnect the capacitor from the input inductor.

3. A driver circuit according to claim 2 wherein the bidirectional switch is one or more of the following: an electromechanical relay; a contactor; a solid-state relay; an electromagnetic relay; a controllable semiconductor switch; a power electronic switch; a MOSFET; an insulated gate bipolar transistor; and a thyristor.

4. A driver circuit according to claim 2 wherein the capacitor is a non-electrolytic capacitor.

5. A driver circuit according to claim 1 wherein the driver circuit is adapted to drive one or more LEDs, the variable impedance thereby providing controllable dimming of the LEDs.

6. A driver circuit according to claim 1 wherein the input current is provided by an AC voltage supply or an AC mains voltage.

7. A driver circuit according to claim 1 comprising a rectifying circuit for rectifying an AC input power into a DC output power.

8. A driver circuit according to claim 7 wherein the rectifying circuit is one of the following: a full-bridge diode rectifier; a half-bridge diode rectifier; a voltage doubling half-bridge diode rectifier; a voltage-multiplying full-bridge diode rectifier; and a voltage multiplying half-bridge diode rectifier.

9. A driver circuit according to claim 1 comprising a voltage smoothing circuit for smoothing an output voltage from a rectifying circuit.

10. A driver circuit according to claim 9 wherein the voltage smoothing circuit is one or more of the following: a capacitor; and a valley-fill circuit.

11. A driver circuit according to claim 1 comprising an output inductor for providing a smoothed output current.

12. A driver circuit according to claim 1 comprising an input capacitor for power factor correction.

13. A driver circuit according to claim 1 comprising an output capacitor for providing a closed path for an output current in case a load circuit driven by the driver circuit is removed or damaged.

14. A driver circuit according to claim 1 wherein the driver circuit is passive.

15. A driver circuit according to claim 1 comprising no electrolytic capacitors.

16. A driver circuit according to claim 1 comprising a control unit for controlling the switching of the switchable capacitors thereby controllably limiting the input current.

17. A method of limiting an input current, the method comprising:
receiving an input current with an input inductor; and
switching one or more switchable capacitors to connect in parallel across the input inductor or to disconnect from the input inductor, the input inductor and the switchable capacitors together thereby providing a variable impedance corresponding to the number of switchable capacitors switched to connect to the input inductor, with the variable impedance variably limiting the input current.

18. (canceled)

19. (canceled)

20. (canceled)

21. (canceled)

22. (canceled)

23. (canceled)

24. A method according to claim 17 comprising closing a path for an output current in case a load circuit driven by the method is removed or damaged.

25. (canceled)

26. (canceled)

27. A method according to claim 17 comprising controlling the switching of the switchable capacitors thereby controllably limiting the input current.

28. An LED lighting system driven by a driver circuit according to claim 1.
